(19) United States
(12) Patent Application Publication
(10) Pub. No.: US 2026/0276031 A1
(43) Pub. Date: Sep. 17, 2026

(54) CONNECTING ROD FOR A VEHICLE

(71) Applicant: Volvo Truck Corporation, GÖTEBORG (SE)

(72) Inventor: Claes KUYLENSTIERNA, Mölnlycke (SE)

(21) Appl. No.: 19/179,628

(22) Filed: Apr. 15, 2025

(30) Foreign Application Priority Data
Apr. 24, 2024 (EP) 24172052.3

(51) Int. Cl. F16C 7/02

(52) U.S. Cl. CPC F16C 7/023

(57) ABSTRACT

A connecting rod for a vehicle is disclosed. The connecting rod comprises a small end, a big end, and a shank extending from the small end to the big end. The big end comprises a base part located adjacent to the shank, and a cap part connectable to the base part. In an assembled state, the base part and the cap part together define an inner circular surface, which defines a central opening which is configured to receive and house two bearing shells for contacting the inner circular surface. The base part is provided with a first groove and the cap part is provided with a second groove, wherein in the assembled state, the first groove and the second groove together form a through hole extending from an external surface of the big end to the inner circular surface.

### CROSS REFERENCE TO RELATED APPLICATIONS

This application claims priority to European Patent Application No. 24172052.3, filed on April 24, 2024, the disclosure and content of which is incorporated by reference herein in its entirety.

### TECHNICAL FIELD

The disclosure relates generally to a connecting rod. In particular aspects, the disclosure relates to a connecting rod for a vehicle. There is also disclosed a connecting rod assembly comprising such a connecting rod, and there is also disclosed a vehicle comprising such a connecting rod or connecting rod assembly. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

A connecting rod in a vehicle may serve as a link between a piston of an engine and a crankshaft. The connecting rod turns the reciprocating motion of the piston into a rotational motion of the crankshaft. The part of the connecting rod that is connected to the crankshaft is commonly referred to as the big end. The big end is supported by a bearing. In order to assemble the bearing into the big end, it is known to fracture split the big end into two halves, placing the bearing and then reassembling the two halves. It may, however, result in quite a challenge to reassemble the big end in such way that the two split surfaces mate accurately, considering that the split surfaces may sometimes be too smooth.

### SUMMARY

According to a first aspect of the disclosure, there is provided a connecting rod for a vehicle. The connecting rod comprises a small end configured to be operatively connected to a piston of a vehicle, a big end configured to be operatively connected to a crankshaft of the vehicle, a shank extending from the small end to the big end, and at least one fastener. The big end comprises a base part located adjacent to the shank, and a cap part. The cap part is connectable to the base part, by the at least one fastener, into an assembled state of the big end, and is disconnectable from the base part into a disassembled state of the big end. In the assembled state of the big end, the base part and the cap part together define an inner circular surface of the big end. The inner circular surface defines a central opening which is configured to receive and house two bearing shells for contacting the inner circular surface. The base part is provided with a first groove and the cap part is provided with a second groove. In the assembled state, the first groove and the second groove together form a through hole extending from an external surface of the big end to the inner circular surface.

The first aspect of the disclosure may seek to enable a facilitation of accurately mating the cap part with the base part when bringing them together into the assembled state of the big end, irrespectively of whether the mating surfaces of the base part and the cap part are smooth or rough. A technical benefit may include that, by providing said though hole forming grooves, they enable any appropriate element to be received in one of the grooves, which element can then align and/or guide the other one of the grooves when bringing the cap part and base part together, thereby facilitating proper alignment between the cap part and the base part.

Optionally, in some examples, the big end may be a fracture-split big end, wherein the base part and the cap part may form the split parts of the big end, each one presenting a fracture surface, wherein the first and the second grooves are provided in a respective one of said fracture surfaces. Although fracture surfaces may often be quite rough, it nevertheless happens that fracture surfaces are too smooth, making it difficult to find the correct mating orientation. A technical benefit may therefore include that, since fracture surfaces may sometimes be quite smooth, it may be challenging to accurately mate the two surfaces, but in combination with the through hole forming grooves an accurate mating is made possible even with less roughness of the fracture surfaces.

Optionally, in some examples, the through hole may have a longitudinal axis, wherein, in said assembled state of the big end, the longitudinal axis is offset relative to the fracture surfaces. A technical benefit may include that hereby a guiding element, such as a pin, rod, etc. which is provided in the through hole, may be enabled to remain in one of the cap part and the base part upon disconnecting the cap part from the base part into the disassembled state of the big end, and to subsequently act as a guide when the cap part and the base part are rejoined. By having the longitudinal axis offset relative to the fracture surfaces, one of the grooves will be larger than the other one of the grooves that form the through hole. Hereby, upon disconnecting the cap part from the base part, any guiding element in the through hole, will be more likely to stay in the larger one of the grooves. Thus, the risk of losing such a guiding element is reduced, and reassembling is facilitated.

Optionally, in some examples, the depth of one of the first and second grooves may be greater than the depth of the other one of the first and second grooves. This too may include a technical benefit that hereby a guiding element, such as a pin, rod, etc. which is provided in the through hole, may be enabled to remain in one of the cap part and the base part upon disconnecting the cap part from the base part into the disassembled state of the big end, and to subsequently act as a guide when the cap part and the base part are rejoined.

Optionally, in some examples, the inner circular surface of the big end may define and extend around a geometrical center axis, wherein the big end has a width extending in parallel with said geometrical center axis, said width extending from a first width end portion to a second width end portion, wherein the through hole may be located closer to one of said width end portions than to the other one. A technical benefit may include that this provides a poka-yoke function. In other words, by having the through hole laterally offset with respect to the width of the big end, i.e., having the through hole closer to one end portion than to another end portion (said width extending between said end portions), when joining the cap part and the base part from the disassembled state, the risk of incorrect assembling can be reduced. If for example the cap part is turned 180° from its intended orientation, and you try to assemble the cap part to the base part, the two grooves will not be able to form the through hole, thus being indicative of incorrect alignment. If you have an additional element inserted in one of the grooves, which element is provided for receiving and guiding the other one of the grooves during assembling, then it may not be possible to mate the two parts if they are incorrectly oriented relative to each other. This further reduces the risk of inadvertently aligning the two parts incorrectly.

Optionally, in some examples, in said assembled state of the big end, the longitudinal extension of the through hole may be substantially perpendicular to the longitudinal extension of said at least one fastener. A technical benefit may include that having a tightening force perpendicular to the longitudinal extension of the through hole may allow for proper alignment with reduced risk of stress and/or strain near the area of the through hole.

Optionally, in some examples, the connecting rod may further comprise a guide configured to extend inside said through hole and to protrude from the inner circular surface into said central opening so as to act as a rotational stop to prevent bearing shells that have been received from moving in a circumferential direction along the inner circular surface. A technical benefit may include that seizures of the bearing may be avoided. In particular, in conventional connecting rods, the bearing shells may start to rotate in the big end, which results in problems with seizures of the bearing. By providing a guide, which may not only facilitate in assembling the cap part to the base part, but which additionally extends into said central opening, such a guide may rotationally lock the bearing shells. Thus, a guide in this example may have dual functionality, namely said rotational locking functionality as well as the functionality of guiding two big end halves when being reassembled.

Optionally, in some examples, the guide may comprise, or may be in the form of, a guide pin having an outer diameter which substantially corresponds to the inner diameter of the through hole such that the guide pin has circumferential contact with wall portions defining said through hole. A technical benefit may include that this provides for a more accurate guiding function when the cap part and the base part are joined together. When manufacturing the connecting rod, the big end may initially suitably be provided with a bore hole (through hole) of a predefined dimension which substantially corresponds to a guide pin. Then, the big end may be split into two halves, i.e., into a base part and a cap part. By making the splitting at the level of the through hole, the base part will be provided with a first groove and the cap part will be provided with a second groove, which together will again form the through hole when the cap part and base part are reassembled (e.g., after the bearing shells have been put in place). The guide pin may be placed in one of the grooves, typically in the deeper one of the grooves if they are of different depths, and may thereby assist in correctly reassembling the base part and the cap part. The guide pin may in the assembled state also extend into the central opening of the big end to provide the previously discussed rotational locking of the bearing shells.

Optionally, in some examples, the guide is a separate component from the big end and any bearing shells to be received in the central opening of the big end. A technical benefit may include that manufacturing may be facilitated, for example compared to designing the bearing to have some type of integral protrusion that extends into the through hole for achieving rotational locking of the bearing shells.

Optionally, in some examples, the guide has a length which is longer than the length of the through hole. A technical benefit may include that this allows the guide to be pushed/knocked into the through hole from the outside of the big end until the pushed/knocked end of the guide becomes flush with the external surface of the big end. When that happens you know that the guide extends an appropriate length into the central opening of the big end.

Optionally, in some examples, the base part may be provided with a third groove and the cap part may be provided with a fourth groove, wherein in said assembled state, the third groove and the fourth groove together form a hole extending from an external surface of the big end, wherein said guide is a first guide, wherein the connecting rod further comprises a second guide configured to extend inside said hole formed by the third and fourth grooves. A technical benefit may include that further guiding assistance is achieved by providing a second guide. It should be understood that the hole formed by the third and fourth grooves does not have to be a through hold, it may be a blind hole. While the first guide may advantageously have dual functionality, namely a guiding function during assembling and a rotation preventing function during operation (preventing a bearing shell from rotating), the second guide may suitably only have the guiding function.

Optionally, in some examples, with respect to the inner circular surface of the big end, the hole formed by the third and fourth grooves may be located substantially diametrically opposite to the through hole formed by the first and second grooves. A technical benefit may include that this may provide for an improved guiding function.

Optionally, in some examples, the hole formed by the third and fourth grooves may have a different diameter compared to the diameter of the through hole formed by the first and second grooves, and/or the second guide may have a different diameter compared to the diameter of the first guide. A technical benefit may include that this enables a poka-yoke functionality, avoiding an incorrect orientation of the cap part relative to the base part during reconnection of these two parts.

According to a second aspect of the disclosure, there is provided a connecting rod assembly comprising the connecting rod of the first aspect (including any example thereof) and a bearing which comprises two bearing shells which are in contact with the inner circular surface of the big end, and which are rotationally locked by the guide extending inside said through hole and protruding from the inner circular surface. The second aspect of the disclosure may seek to provide corresponding technical benefits as discussed above in relation to the first aspect and examples thereof.

Optionally, in some examples, the guide extending inside said through hole may have a length which is shorter than the sum of the lengths of the through hole and the thickness of the bearing. A technical benefit may include that when the outer end of the guide is flush with the external surface of the big end, even though the guide provides a rotational locking function to the bearing shells, it will not extend beyond the bearing and will thus not interfere with the bearing function.

According to a third aspect of the disclosure, there is provided a vehicle comprising the connecting rod of the first aspect (including any example thereof) or the connecting rod assembly of the second aspect (including any example thereof). The third aspect of the disclosure may seek to provide corresponding technical benefits as discussed above in relation to the first and second aspects and examples thereof.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 schematically illustrates a vehicle according to one example.

FIG. 2 illustrates schematically parts of a connecting rod assembly according to one example.

FIG. 3 illustrates schematically a side view of a connecting rod according to one example.

FIG. 4 illustrates a cross-sectional view of the connecting rod in FIG. 3.

FIG. 5 illustrates a detail of a connecting rod according to one example.

FIG. 6 illustrates schematically a connecting rod according to another example.

### DETAILED DESCRIPTION

The detailed description set forth below provides information and examples of the disclosed technology with sufficient detail to enable those skilled in the art to practice the disclosure.

Fraction splitting a big end of a crankshaft is a known method for being able to conveniently place a bearing into the big end. However, since the split surfaces are sometimes smooth, it may be challenging to accurately rejoin the two split parts of the big end. According to the present disclosure, however, the big end is provided with a through hole which, when the big end is fraction-split into two parts, is represented by one hole forming groove in one of the split parts and another hole forming groove in the other one of the split parts. Such grooves enable an aligning element to be received for facilitating accurate alignment of the two parts when rejoining the two parts.

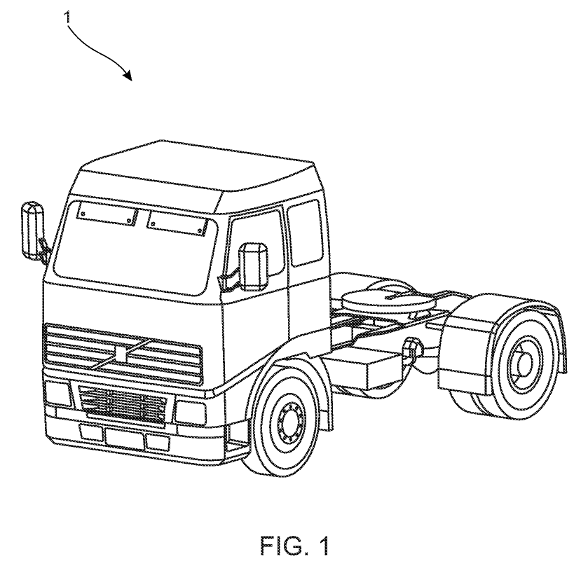

FIG. 1 schematically illustrates a vehicle 1 according to one example of this disclosure. More specifically, the illustrated vehicle 1 is a heavy-duty vehicle in the form of a tractor unit, which may be configured to pull a trailer unit. However, the teachings of the present disclosure may be implemented for other types of vehicles as well. The vehicle 1 may be a driver-operated vehicles or a self-driving autonomous vehicle. The vehicle 1 may comprise a connecting rod or a connecting rod assembly, such as the ones that have previously been discussed in this disclosure. Examples of such a connecting rod and connecting rod assembly will now be discussed with reference to the other drawing figures.

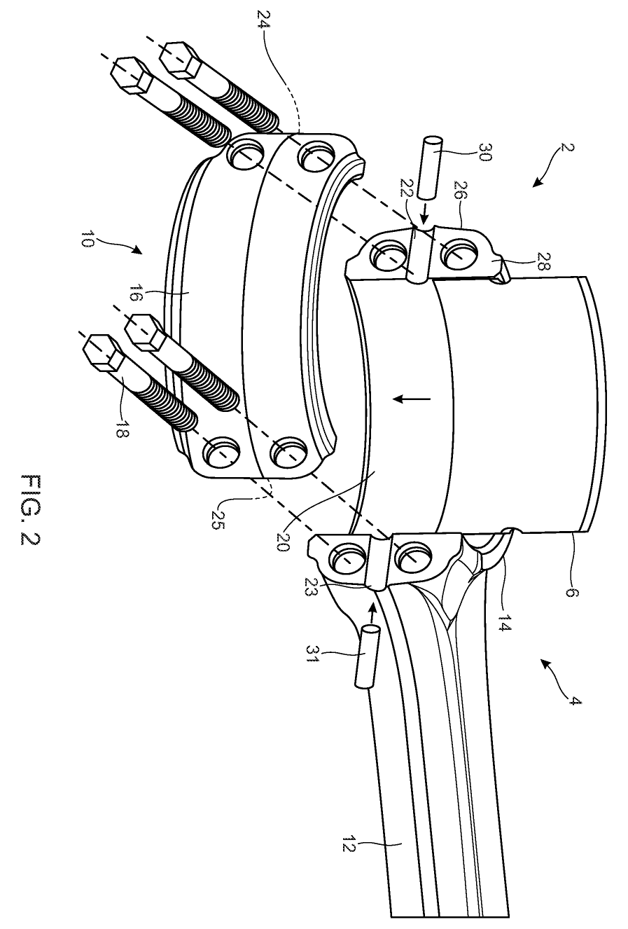

FIG. 2 illustrates schematically parts of a connecting rod assembly 2 according to one example. The connecting rod assembly comprises a connecting rod 4 and a bearing, wherein the bearing comprises two bearing shells 6 (only one shown in FIG. 2). The connecting rod 4 is intended to be used in a vehicle, such as the vehicle 1 in FIG. 1 or in other suitable vehicles. In a vehicle, the connecting rod 4 may serve as a link between a piston of an engine and a crankshaft. The connecting rod 4 turns the reciprocating motion of the piston into a rotational motion of the crankshaft. Accordingly, the connecting rod 4 comprises a small end (not shown in FIG. 2) configured to be operatively connected to a piston of a vehicle and a big end 10 configured to be operatively connected to a crankshaft of the vehicle. A shank 12 extends from the small end to the big end 10.

As illustrated in FIG. 2, the big end 10 comprises a base part 14 located adjacent to the shank 12. The big end 10 also comprises a cap part 16. In FIG. 2, the big end 10 is illustrated in a disassembled state. However, the cap part 16 is connectable to the base part 14 by means of at least one fastener 18. In this example, the connecting rod 4 comprises four fasteners 18 (here illustrated as bolts), however, other number of fasteners are also conceivable, such as two fasteners. The big end 10 will be in an assembled state when the cap part 16 has been connected to the base part 14 by means of said at least one fastener 18. If the fasteners 18 are removed, the cap part 16 can once again be disconnected from the base part 14 into the illustrated disassembled state.

In the assembled state of the big end 10, the base part 14 and the cap part 16 together define an inner circular surface 20 of the big end 10. In its turn, the inner circular surface 20, in said assembled state, defines a central opening which is configured to receive and house the two bearing shells 6 for contacting the inner circular surface 20 (this is schematically illustrated by the arrow showing how one of the bearing shells 6 is being put in place on the inner circular surface 20).

The base part 14 is provided with a first groove 22 and the cap part 16 is provided with a second groove 24 (not visible in FIG. 2). In the assembled state, the first groove 22 and the second groove 24 together form a through hole extending from an external surface 26 of the big end 10 to the inner circular surface 20.

As understood from FIG. 2, the big end 10 may be a fraction-split big end 10. The base part 14 and the cap part 16 may thus form the split parts of the big end 10. Each one of the base part 14 and the cap part 16 presents a fracture surface 28. The first groove 22 and the second groove 24 are provided in a respective one of the fracture surfaces 28. When manufacturing the connecting rod 4 said through hole may suitably be present in the big end 10 before fraction-splitting the big end 10. Hereby, the location of the through hole may already be predefined before the actual fraction splitting. By purposefully selecting the geometrical plane in which the fraction splitting should be made, the relative proportions between the resulting first groove 22 (in the base part 14) and second groove 24 (in the cap part 16) may be controlled. For example, the longitudinal axis of the through hole may suitably be offset relative to the geometrical plane in which the fraction splitting is intended to be made. Thus, in the assembled state of the big end 10, the longitudinal axis of the through hole may be offset relative to the fracture surfaces 28. Thus, the depth of one of the first groove 22 and the second groove 24 may be greater than the depth of the other one of the first groove 22 and the second groove 24.

As further illustrated in FIG. 2, the big end 10 may suitably comprise an aligning element, in particular a guide such as the herein illustrated guide pin 30. The guide pin 30 may have dual functionality. A first functionality is that the guide pin 30 may extend inside the through hole formed by the first groove 22 and the second groove 24 and protrude from the inner circular surface 20 into the central opening (formed by the inner circular surface 20 in said assembled state) so as to act as a rotational stop to prevent the received bearing shells 6 from moving in a circumferential direction along the inner circular surface 20. For instance, the pin 30 may engage a notch, recess or similar in one or both of the bearing shells 6. If, for example, it is desired to replace the bearing shells 6, then after disconnecting the cap part 16 from the base part 14, the guide pin 30 may remain positioned in the deeper one of the first and second grooves 22, 24. The second functionality of the guide pin 30 is to facilitate alignment between the cap part 16 and the base part 14 when joining them into the assembled state. By making sure that when bringing the two parts 14, 16 together, the other groove will also mate with the guide pin 30, a correct alignment between the cap part 16 and the base part 14 is achievable, irrespectively of the fracture surfaces 28 being relatively rough or smooth. As can be understood, the guide pin 30 may suitably have an outer diameter which substantially corresponds to the inner diameter of the through hole (formed by the first and second grooves 22, 24 in said assembled state) such that the guide pin 30 has circumferential contact with wall portions defining said through hole. The guide pin 30 may suitably be a separate component from the big end 10 and the bearing shells 6, which may be inserted into the through hole after fraction splitting. The guide pin 30 may suitably have a length which is shorter than the sum of the lengths of the through hole and the thickness of the bearing. Thus, when the guide pin 30 is flush with the external surface 26 of the big end 10, it may protrude sufficiently enough to rotationally lock the bearing shells 6, but short enough to avoid interfering with the inner bearing geometry.

Optionally, as illustrated in FIG. 2, the base part 14 may be provided with a third groove 23. Analogously to there being a second groove 24 in the cap part 16 opposite to the first groove 22 in the base part 14 to form a through hole, there may similarly be provided a fourth groove 25 in the cap part 16 opposite to the third groove 23 in base part 14. Thus, in the assembled state, the third groove 23 and the fourth groove 25 may together from a hole extending from the external surface 26 of the big end 10. Furthermore, similarly to there being a guide pin 30 configured to extend inside the through hole formed by the first and second grooves 22, 24 in the assembled state of the big end 10, there may also be a guide pin 31 configured to extend inside the hole formed by the third and fourth grooves 23, 25 in the assembled state of the big end 10. Thus, in general terms, there may be a first guide (here illustrated as guide pin 30) configured to extend into the through hole formed by the first and second grooves 22, 24, and a second guide (here illustrated as guide pin 31) configured to extend inside the hole formed by the third and fourth grooves 23, 25. Although it can be understood from the illustration of the third groove 23 in FIG. 2, that the hole formed by the third and fourth grooves 23, 25 may be a through hole, it should also be understood that in other examples it may be a blind hole. Thus, in such other examples, the first mentioned guide pin 30 may have the above discussed dual functionality, while the second mentioned guide pin 31 may just have the aligning/guiding functionality (i.e., not the rotational-locking function with respect to the bearing shells 6).

As can be understood from the illustration in FIG. 2, in at least some examples, with respect to the inner circular surface 20 of the big end 10, the hole formed by the third and fourth grooves 23, 25 may suitably be located substantially diametrically opposite to the through hole formed by the first and second grooves 22, 24.

The inner circular surface 20 in FIG. 2 may suitably be machined together with the guide pin 30. Hereby, the machine end portion of the guide pin 30 may obtain an integrated shape with the machined inner circular surface 20. The guide pin 30 will then suitably protrude the same distance into the inner circular surface 20 when the guide pin 30 is pushed in through the through hole.

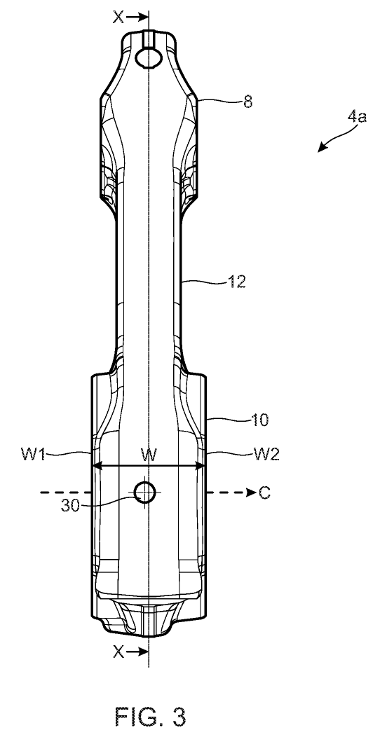

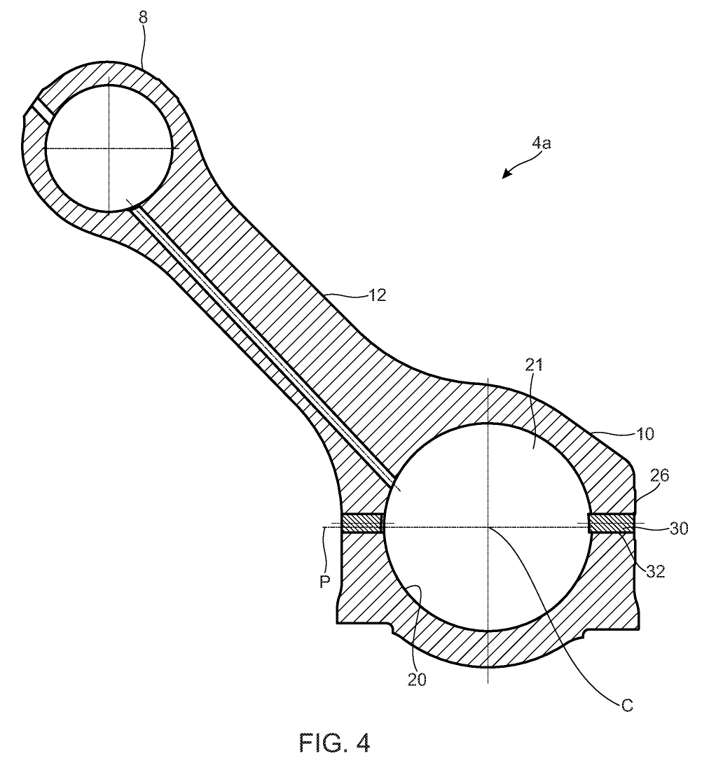

FIG. 3 illustrates schematically a side view of a connecting rod 4a according to one example. FIG. 4 illustrates a cross-sectional view of the connecting rod 4a in FIG. 3, taken along line X-X in FIG. 3.

FIG. 4 illustrates that the connecting rod 4a has a small end 8, a big end 10, and a shaft 12 interconnecting the small end 8 with the big end 10. In the assembled state of the big end 10 shown in FIG. 4, it can be seen that the inner circular surface 20 defines a central opening 21. As can also be seen in FIG. 4, the inner circular surface 20 of the big end 10 may define and extend around a geometrical centre axis C.

The view shown in FIG. 3 demonstrates that the big end 10 may have a width W extending in parallel with the geometrical centre axis C. In particular, the width W may extend from a first width end portion W1 to a second width end portion W2. As can be seen in FIG. 3 the guide pin 30 (and thus the through hole) is located closer to the first width end portion W1 than to the second width end portion W2. Such a lateral offset of the guide pin 30 and the through hole provides for a poka-yoke function. FIG. 4 illustrates another offset, namely with respect to the geometrical plane P of the fraction split. This offset of the guide pin 30 and the through hole 32 results in that one of the grooves forming the through hole 32 is deeper than the other one of the grooves, as has been discussed previously. As can further be seen in FIG. 4, the guide pin 30 has a length which is longer than the length of the through hole 32. Hereby, the guide pin 30 may be pushed/knocked from the outside into the through hole 30 until its end becomes flush with the external surface 26 of the big end 10. In this position, the guide pin 30 extends an appropriate length into the central opening defined by the inner circular surface 20 of the big end 10, enough to provide the rotation prevention function for the bearing shells.

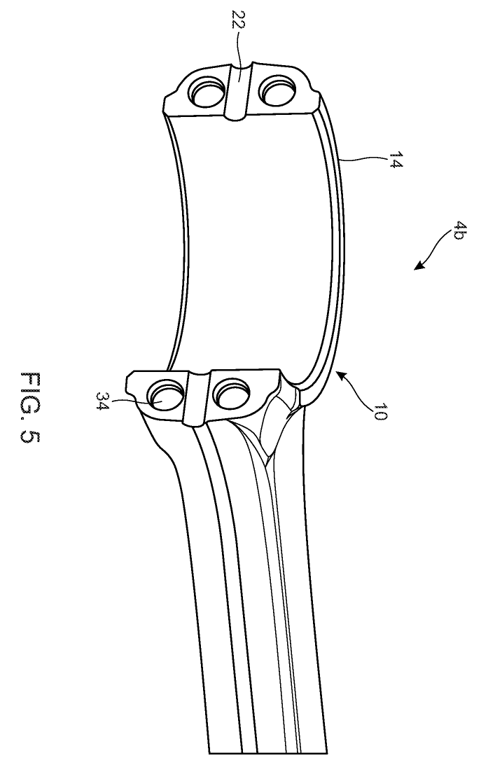

FIG. 5 illustrates a detail of a connecting rod 4b according to one example. More specifically, it illustrates the base part 14 in the disassembled state of the big end 10. As can be seen, there are four bores 34, suitably threaded bores, provided. The four bores 34 are configured to receive fastener portions. For example, the fasteners (such as the fasteners 18 -shown in the example of FIG. 2) may be in the form of bolts having threaded shafts, wherein the threaded shafts of the bolts are to be engaged with the mating threads in the bores 34 when the cap part is connected to the base part 14 of the big end 10. As can be seen in FIG. 5, the bores 34 extend in a direction substantially perpendicularly to the longitudinal extension of the first groove 22 (and thus perpendicularly to the longitudinal extension of the through hole formed by the first and second grooves). Thus, from this it can be understood that in at least some examples, in the assembled state of the big end 10, the longitudinal extension of the through hole may be substantially perpendicular to the longitudinal extension of said at least one fastener.

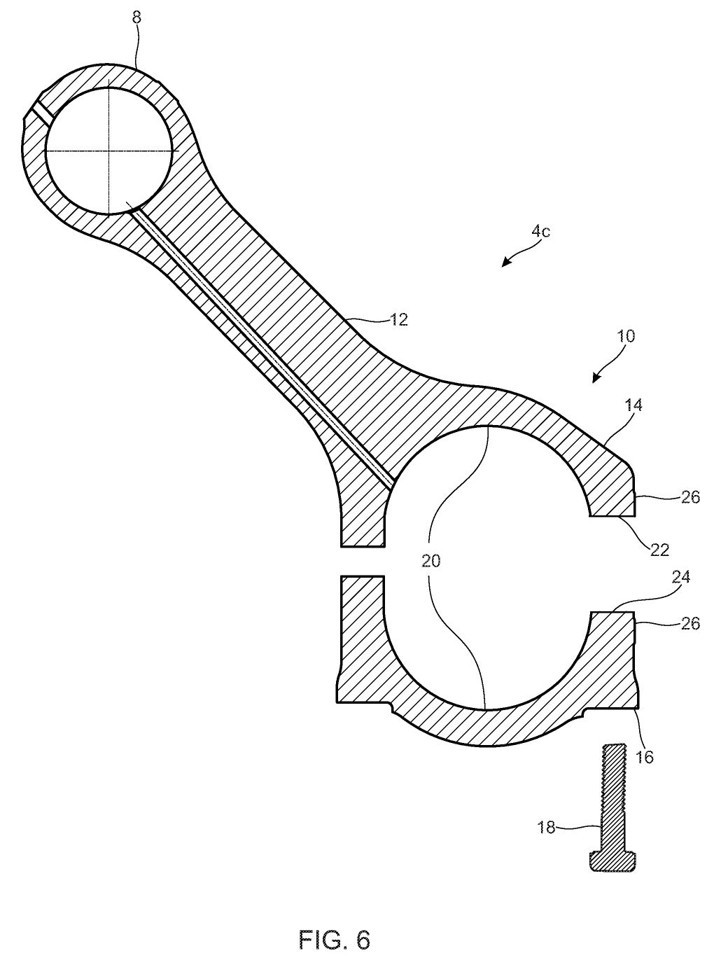

FIG. 6 illustrates schematically (in a cross-sectional view) a connecting rod 4c according to another example. In particular, FIG. 6 schematically illustrates a connecting rod 4c for a vehicle, the connecting rod 4c comprising:

a small end 8 configured to be operatively connected to a piston of a vehicle, a big end 10 configured to be operatively connected to a crankshaft of the vehicle, and a shank 12 extending from the small end to the big end 10, and

at least one fastener 18,

wherein the big end 10 comprises:

a base part 14 located adjacent to the shank 12, and

a cap part 16,

wherein the cap part 16 is connectable to the base part 14, by said at least one fastener 18, into an assembled state of the big end 10, and is disconnectable from the base part 14 into a disassembled state of the big end 10 (FIG. 6 showing the disassembled state of the big end 10),

wherein, in said assembled state of the big end 10, the base part 14 and the cap part 16 together define an inner circular surface 20 of the big end 10, the inner circular surface defining 20 a central opening which is configured to receive and house two bearing shells for contacting said inner circular surface 20,

wherein the base part 14 is provided with a first groove 22 and the cap part 16 is provided with a second groove 24, wherein in said assembled state, the first groove 22 and the second groove 24 together form a through hole extending from an external surface 26 of the big end 10 to said inner circular surface 20.

Example 1: A connection rod for a vehicle, the connecting rod comprising: a small end configured to be operatively connected to a piston of a vehicle, a big end configured to be operatively connected to a crankshaft of the vehicle,

and a shank extending from the small end to the big end, and

at least one fastener,

wherein the big end comprises:

a base part located adjacent to the shank, and

a cap part,

wherein the cap part is connectable to the base part, by said at least one fastener, into an assembled state of the big end, and is disconnectable from the base part into a disassembled state of the big end,

wherein, in said assembled state of the big end, the base part and the cap part together define an inner circular surface of the big end, the inner circular surface defining a central opening which is configured to receive and house two bearing shells for contacting said inner circular surface,

wherein the base part is provided with a first groove and the cap part is provided with a second groove, wherein in said assembled state, the first groove and the second groove together form a through hole extending from an external surface of the big end to said inner circular surface.

Example2: The connecting rod of example 1, wherein the big end is a fracture-split big end, wherein the base part and the cap part form the split parts of the big end, each one presenting a fracture surface, wherein the first and the second grooves are provided in a respective one of said fracture surfaces.

Example 3: The connecting rod of example 2, wherein the through hole has a longitudinal axis, wherein, in said assembled state of the big end, the longitudinal axis is offset relative to the fracture surfaces.

Example 4: The connecting rod of any one of examples 1-3, wherein the depth of one of the first and second grooves is greater than the depth of the other one of the first and second grooves.

Example 5: The connecting rod of any of examples 1-4, wherein the inner circular surface of the big end defines and extends around a geometrical center axis, wherein the big end has a width extending in parallel with said geometrical center axis, said width extending from a first width end portion to a second width end portion, wherein the through hole is located closer to one of said width end portions than to the other one.

Example 6: The connecting rod of any of examples 1-5, wherein in said assembled state of the big end, the longitudinal extension of the through hole is substantially perpendicular to the longitudinal extension of said at least one fastener.

Example 7: The connecting rod of any one of examples 1-6, further comprising a guide configured to extend inside said through hole and to protrude from the inner circular surface into said central opening so as to act as a rotational stop to prevent bearing shells that have been received from moving in a circumferential direction along the inner circular surface.

Example 8: The connecting rod of example 7, wherein the guide comprises, or is in the form of, a guide pin having an outer diameter which substantially corresponds to the inner diameter of the through hole such that the guide pin has circumferential contact with wall portions defining said through hole.

Example 9: The connecting rod of any of examples 7-8, wherein the guide is a separate component from the big end and any bearing shells to be received in the central opening of the big end.

Example 10: The connecting rod of any of examples 7-9, wherein the guide has a length which is longer than the length of the through hole.

Example 11: The connecting rod of example any of examples 7-10, wherein the base part is provided with a third groove and the cap part is provided with a fourth groove, wherein in said assembled state, the third groove and the fourth groove together form a hole extending from an external surface of the big end, wherein said guide is a first guide, wherein the connecting rod further comprises a second guide configured to extend inside said hole formed by the third and fourth grooves.

Example 12: The connecting rod of example 11, wherein, with respect to the inner circular surface of the big end, the hole formed by the third and fourth grooves is located substantially diametrically opposite to the through hole formed by the first and second grooves.

Example 13: The connecting rod of any of examples 9-10, wherein the hole formed by the third and fourth grooves has a different diameter compared to the diameter of the through hole formed by the first and second grooves, and/or the second guide has a different diameter compared to the diameter of the first guide.

Example 14: A connecting rod assembly comprising: - the connecting rod of any of examples 7-13, and - a bearing which comprises two bearing shells which are in contact with the inner circular surface of the big end, and which are rotationally locked by the guide extending inside said through hole and protruding from the inner circular surface.

Example 15: The connecting rod assembly of example 14, wherein the guide extending inside said through hole has a length which is shorter than the sum of the lengths of the through hole and the thickness of the bearing.

Example 16: A vehicle comprising the connecting rod of any of examples 1-13 or the connecting rod assembly according to any of examples 14-15.

The terminology used herein is for the purpose of describing particular aspects only and is not intended to be limiting of the disclosure. As used herein, the singular forms "a," "an," and "the" are intended to include the plural forms as well, unless the context clearly indicates otherwise. As used herein, the term "and/or" includes any and all combinations of one or more of the associated listed items. It will be further understood that the terms "comprises," "comprising," "includes," and/or "including" when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as "below" or "above" or "upper" or "lower" or "horizontal" or "vertical" may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being "connected" or "coupled" to another element, it can be directly connected or coupled to the other element, or intervening elements may be present. In contrast, when an element is referred to as being "directly connected" or "directly coupled" to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A connecting rod for a vehicle, the connecting rod comprising:
a small end configured to be operatively connected to a piston of a vehicle;
a big end configured to be operatively connected to a crankshaft of the vehicle;
a shank extending from the small end to the big end; and
at least one fastener,
wherein the big end comprises:
a base part located adjacent to the shank, and
a cap part,
wherein the cap part is connectable to the base part, by the at least one fastener, into an assembled state of the big end, and is disconnectable from the base part into a disassembled state of the big end,
wherein, in the assembled state of the big end, the base part and the cap part together define an inner circular surface of the big end, the inner circular surface defining a central opening which is configured to receive and house two bearing shells for contacting the inner circular surface, and
wherein the base part is provided with a first groove and the cap part is provided with a second groove, wherein in the assembled state, the first groove and the second groove together form a through hole extending from an external surface of the big end to the inner circular surface.

2. The connecting rod of claim 1, wherein the big end is a fracture-split big end, wherein the base part and the cap part form the split parts of the big end, each one presenting a fracture surface, wherein the first and the second grooves are provided in a respective one of the fracture surfaces.

3. The connecting rod of claim 2, wherein the through hole has a longitudinal axis, wherein, in the assembled state of the big end, the longitudinal axis is offset relative to the fracture surfaces.

4. The connecting rod of claim 1, wherein the depth of one of the first and second grooves is greater than the depth of the other one of the first and second grooves.

5. The connecting rod of claim 1, wherein the inner circular surface of the big end defines and extends around a geometrical centre axis, wherein the big end has a width extending in parallel with the geometrical centre axis, the width extending from a first width end portion to a second width end portion, wherein the through hole is located closer to one of the width end portions than to the other one.

6. The connecting rod of claim 1, wherein in the assembled state of the big end, the longitudinal extension of the through hole is substantially perpendicular to the longitudinal extension of the at least one fastener.

7. The connecting rod of claim 1, further comprising a guide configured to extend inside the through hole and to protrude from the inner circular surface into the central opening so as to act as a rotational stop to prevent bearing shells that have been received from moving in a circumferential direction along the inner circular surface.

8. The connecting rod of claim 7, wherein the guide comprises, or is in the form of, a guide pin having an outer diameter which substantially corresponds to the inner diameter of the through hole such that the guide pin has circumferential contact with wall portions defining the through hole.

9. The connecting rod of claim 7, wherein the guide is a separate component from the big end and any bearing shells to be received in the central opening of the big end.

10. The connecting rod of claim 7, wherein the guide has a length which is longer than the length of the through hole.

11. The connecting rod of claim 7, wherein the base part is provided with a third groove and the cap part is provided with a fourth groove, wherein in the assembled state, the third groove and the fourth groove together form a hole extending from an external surface of the big end, wherein the guide is a first guide, wherein the connecting rod further comprises a second guide configured to extend inside the hole formed by the third and fourth grooves.

12. The connecting rod of claim 11, wherein, with respect to the inner circular surface of the big end, the hole formed by the third and fourth grooves is located substantially diametrically opposite to the through hole formed by the first and second grooves.

13. The connecting rod of claim 11, wherein the hole formed by the third and fourth grooves has a different diameter compared to the diameter of the through hole formed by the first and second grooves, and/or the second guide has a different diameter compared to the diameter of the first guide.

14. A connecting rod assembly comprising:
the connecting rod of claim 7, and
a bearing which comprises two bearing shells which are in contact with the inner circular surface of the big end, and which are rotationally locked by the guide extending inside the through hole and protruding from the inner circular surface.

15. The connecting rod assembly of claim 14, wherein the guide extending inside the through hole has a length which is shorter than the sum of the lengths of the through hole and the thickness of the bearing.

16. A vehicle comprising the connecting rod of claim 1.

17. A vehicle comprising the connecting rod assembly according to claim 14.
